(19) United States
(12) Patent Application Publication
(10) Pub. No.: US 2025/0320903 A1
(43) Pub. Date: Oct. 16, 2025

(54) MOUNT FOR VIBRATION INSULATION

(71) Applicants: HYUNDAI MOTOR COMPANY, Seoul (KR); KIA CORPORATION, Seoul (KR)

(72) Inventor: Jae Hyung Yun, Ansan-si (KR)

(73) Assignees: HYUNDAI MOTOR COMPANY, Seoul (KR); KIA CORPORATION, Seoul (KR)

(21) Appl. No.: 18/922,133

(22) Filed: Oct. 21, 2024

(30) Foreign Application Priority Data
Apr. 11, 2024 (KR) 10-2024-0048489

(51) Int. Cl. F16F 1/38; B60K 1/04; F16F 7/12

(52) U.S. Cl. CPC F16F 1/3842; F16F 7/12; B60K 1/04; F16F 2230/0041

(57) ABSTRACT

A mount is configured to control and insulate movement and vibration of a vehicle component mounted to a vehicle body. The mount includes an inner pipe coupled to the vehicle body, an outer pipe disposed on an external side of the inner pipe and coupled to the vehicle component mounted to the vehicle body, and a first insulator between the inner pipe and the outer pipe. The first insulator is configured to insulate vibration of the vehicle component and to stop a first direction movement of the vehicle component occurring in an axial direction of the inner pipe. The mount further includes a second insulator disposed to be axially spaced apart from the first insulator. The second insulator is configured to stop a second direction movement of the vehicle component occurring in the axial direction of the inner pipe and a movement of the vehicle component occurring in a radial direction of the inner pipe.

### CROSS-REFERENCE TO RELATED APPLICATION

This application claims, under 35 U.S.C. § 119(a), the benefit of and priority to Korean Patent Application No. 10-2024-0048489, filed on Apr. 11, 2024, the entire contents of which are incorporated herein by reference.

### TECHNICAL FIELD

The present disclosure relates to a mount for vibration insulation. More particularly, the present disclosure relates to a mount configured to control movement of a vehicle component and insulate vibration of the vehicle component, wherein the movement and vibration are caused by an external force.

### BACKGROUND

Recently, as the size of a motor reducer among the components mounted on a vehicle increases and the size of a fuel cell stack and the sizes of other accessories increase, the fuel cell stack and the motor reducer are often mounted separately.

A conventional hydrogen fuel vehicle is generally of the type in which the fuel cell stack and accessories are integrated with the motor reducer. When the fuel cell stack and the motor reducer are integrated into each other, the fuel cell stack, motor, and motor reducer are mounted on the vehicle body using a motor mount. Generally, the conventional hydrogen fuel vehicle supported the fuel cell stack and accessories all together using the motor mount.

Conventionally, when the fuel cell stack and the motor reducer are mounted separately on the hydrogen fuel vehicle, a separate structure for insulating the vibration of the fuel cell stack and accessories and stopping the movement of the fuel cell stack and accessories was not provided based on the reason that the fuel cell stack and accessories are components that do not generate power.

However, recently, as the movement of fuel cell stack and accessories, equivalent to a weight of about 200 kgf, occurred by an external force has caused a vibration problem while driving and has caused shaking, i.e., vibration, due to large displacement movement such as bumps, the movement of the fuel cell stack needs to be controlled.

For these reasons, when the fuel cell stack and the motor reducer are mounted separately on the vehicle body, a separate insulator for stack mounting is needed to couple the fuel cell stack to the vehicle body.

Although the fuel cell stack and accessories do not generate power, they vibrate and move due to an external force. Therefore, the insulator to mount the fuel cell stack to the vehicle body needs to prevent shock transmission from the outside to the fuel cell stack and accessories and needs to avoid resonance frequencies by separating frequencies and to improve travelling performance (i.e., driving performance) by controlling the movement.

The above information disclosed in this Background section is only to enhance understanding of the background of the present disclosure. Therefore, the Background section may contain information that does not form the prior art that is already known to a person of ordinary skill in the art.

### SUMMARY

The present disclosure has been made in an effort to solve the above-described problems associated with the prior art. Objects of the present disclosure are to provide a mount having a structure configured to, when a vehicle component vibrates and moves by an external force, insulate the vibration and control the movement.

The objects of the present disclosure are not limited to the foregoing. Other objects not mentioned herein should be more clearly understood by those of ordinary skill in the art to which the present disclosure pertains based on the description below.

In one aspect, the present disclosure provides a mount for vibration insulation. The mount includes: an inner pipe coupled to a vehicle body; an outer pipe disposed on an external side of the inner pipe and coupled to a vehicle component mounted to the vehicle body; and a first insulator formed between the inner pipe and the outer pipe. The first insulator is configured to insulate vibration of the vehicle component and to stop a first direction movement of the vehicle component occurring in an axial direction of the inner pipe (i.e., along the axis of the inner pipe). The mount also includes a second insulator disposed to be axially spaced apart from the first insulator. The second insulator is configured to stop a second direction movement of the vehicle component occurring in the axial direction of the inner pipe (i.e., along the axis of the inner pipe) and a movement of the vehicle component occurring in a radial direction of the inner pipe.

In an embodiment, the second insulator may be provided (e.g., disposed) on a plate coupled to an end portion of the inner pipe. The second insulator may be, by the plate, fixed at a position facing the first insulator with a predetermined gap therebetween.

In another embodiment, the first insulator may include a bridge portion provided (e.g., placed or disposed) between the inner pipe and the outer pipe. The bridge portion may be affixed to (e.g., glued to) an outer circumferential surface of the inner pipe and to an inner circumferential surface of the outer pipe. The first insulator may also include a first axial stopping portion extending from a first end portion of the bridge portion and facing the vehicle body with a predetermined gap therebetween. The bridge portion may have a second end portion having formed therein a concavely recessed groove.

In still another embodiment, the second insulator may include a second axial stopping portion provided (e.g., placed or disposed) on the plate and being axially spaced apart and separated from the outer pipe. The second insulator may also include a radial stopping portion extending toward the bridge portion from the second axial stopping portion and being disposed within the groove.

In yet another embodiment, the radial stopping portion may have a volume smaller than a volume of the groove. The radial stopping portion may be separated from the bridge portion while being disposed within the groove.

In still yet another embodiment, the outer pipe may have an end portion provided with a support portion configured to support the first axial stopping portion selectively pressed by the vehicle body.

Other aspects and embodiments of the present disclosure are discussed below.

It should be understood that the terms “vehicle” or “vehicular” or other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are described in detail with reference to certain embodiments thereof illustrated in the accompanying drawings which are given hereinbelow by way of illustration only, and thus are not limitative of the present disclosure, and wherein:

FIG. 1 is a combined perspective view illustrating a mount for vibration insulation (hereinafter, “vibration insulation mount”) according to an embodiment of the present disclosure;

FIG. 2 is an exploded perspective view illustrating a vibration insulation mount according to an embodiment of the present disclosure;

FIG. 3 is a cross-sectional view of a vibration insulation mount according to an embodiment of the present disclosure;

FIG. 4 is a view illustrating a state in which a vibration insulation mount according to an embodiment of the present disclosure is coupled to a vehicle body;

FIG. 5 is a view illustrating a state in which a vibration insulation mount according to an embodiment of the present disclosure is coupled to a bracket of a vehicle component; and

FIG. 6 is a view illustrating the assembly process of a vibration insulation mount according to an embodiment of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawings.

### DETAILED DESCRIPTION

Hereinafter, embodiments of the present disclosure are described with reference to the accompanying drawings. The matters described in the attached drawings may be different from those implemented in order to facilitate description of the embodiments of the present disclosure.

In this specification, the terms “first,” “second,” and the like may be used to describe various components, but the components are not limited to the terms. These terms are only used to distinguish one component from another. For example, a first component could be termed a second component, and similarly, a second component could be termed a first component, without departing from the scope of embodiments of the present disclosure.

In this specification, terms such as “axial direction,” “radial direction,” and “circumferential direction” are determined with respect to the vibration insulation mount and the components of the mount unless otherwise specified. For example, the terms “axial direction,” “radial direction,” and “circumferential direction” may respectively be the axial direction, radial direction, and circumferential direction of an inner pipe, which is one of the components of the mount.

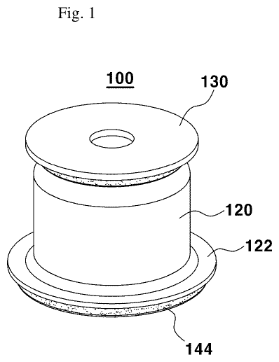

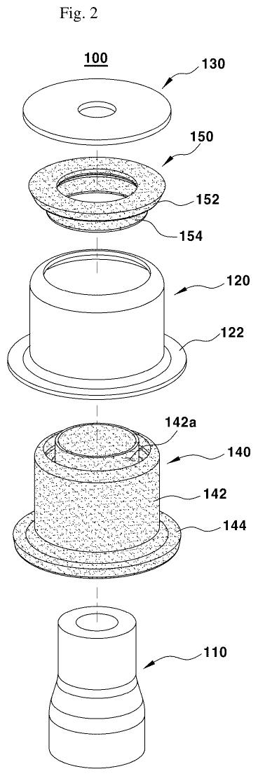

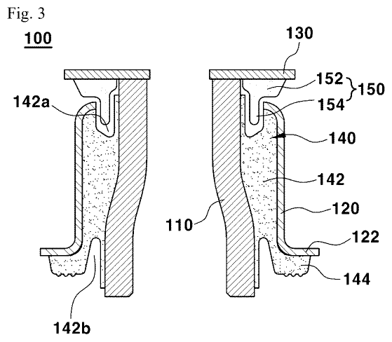

As illustrated in FIGS. 1-3, a vibration insulation mount 100 according to an embodiment of the present disclosure includes an inner pipe 110, an outer pipe 120, and a plate 130. The inner pipe 110, the outer pipe 120, and the plate 130 are made of metal, and a first insulator 140 and a second insulator 150 are made of rubber.

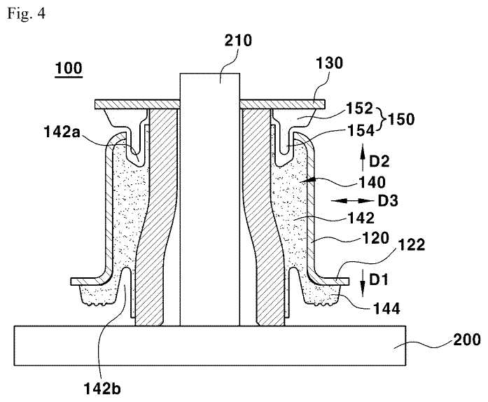

The inner pipe 110 has a hollow pipe structure. Referring to FIG. 4, the inner pipe 110 is coupled to be fixed to a vehicle body 200 through a bolt member 210.

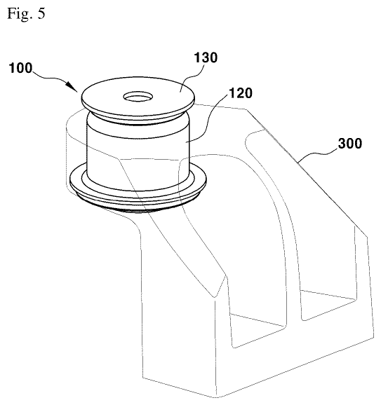

The outer pipe 120 has a hollow pipe structure. The outer pipe 120 is disposed on a radially external side of the inner pipe 110 and coupled to a bracket of a vehicle component (see numeral 300 in FIG. 5) mounted to the vehicle body 200. The outer pipe 120 is arranged coaxially with the inner pipe 110.

The plate 130 has a flat plate-shaped structure. The plate 130 is stacked and coupled to a first end portion of the inner pipe 110 in the axial direction. The plate 130 has a central portion open so that the bolt member 210 may penetrate therethrough. The bolt member 210 is coupled to the vehicle body 200 by penetrating the inner pipe 110 and the plate 130. Although not specifically illustrated in the drawing, the bolt member 210 may be coupled to the vehicle body 200 by being fastened to a nut member. A second end portion of the inner pipe 110 may be stacked and mounted on the vehicle body 200.

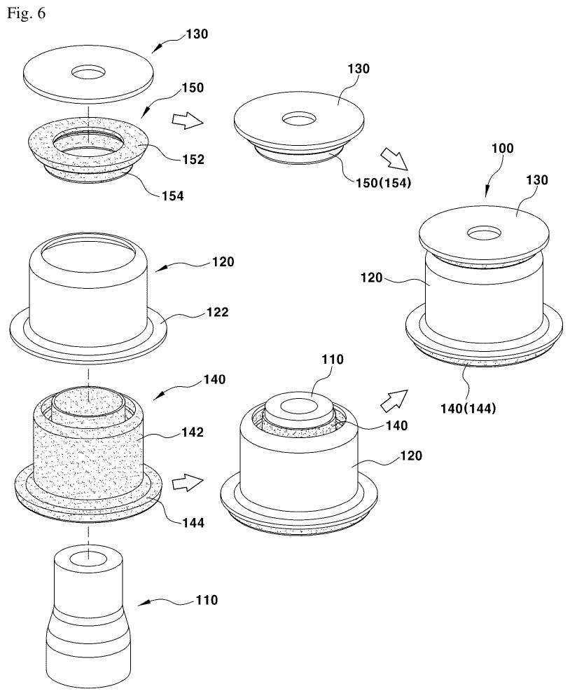

The first insulator 140 is vulcanized between the inner pipe 110 and the outer pipe 120 (see FIG. 6). The inner circumferential surface of the first insulator 140 is bonded to be fixed to the outer circumferential surface of the inner pipe 110. The outer circumferential surface of the first insulator 140 is bonded to be fixed to the inner circumferential surface of the outer pipe 120.

To insulate and stop the vibration and movement of the vehicle component, the first insulator 140 includes a bridge portion 142 and a first axial stopping portion 144.

The bridge portion 142 is disposed between the inner pipe 110 and the outer pipe 120. The bridge portion 142 is bonded to (e.g., glued to) be fixed to the outer circumferential surface of the inner pipe 110 and to the inner circumferential surface of the outer pipe 120. The bridge portion 142 is configured to insulate the vibration of the vehicle component coupled to the outer pipe 120 through a bracket 300. The bridge portion 142 insulates the vibration of the vehicle component while expanding and contracting by the vibration of the vehicle component.

The bridge portion 142 is provided with a first groove 142a at an axial first end portion thereof and is provided with a second groove 142b at an axial second end portion thereof. In other words, the bridge portion 142 has the first end portion having formed therein the first groove 142a and has the second end portion having formed therein the second groove 142b. The first groove 142a and the second groove 142b each have a structure that is concavely recessed by a predetermined depth. The first groove 142a and the second groove 142b each extend seamlessly in the circumferential direction.

The first axial stopping portion 144 extends from the second end portion of the bridge portion 142. The first axial stopping portion 144 is disposed at a predetermined gap from the vehicle body 200 to which the inner pipe 110 is coupled (see FIG. 4).

The first insulator 140 having said structure may insulate the vibration of the vehicle component using the bridge portion 142 and may stop a first direction movement (see D1 in FIG. 4) of the vehicle component using the first axial stopping portion 144. The bridge portion 142 may insulate vibrations in all directions that occur in the vehicle component by external forces. The first axial stopping portion 144 may stop the first direction movement D1 among the movements of the vehicle component that occur in the axial direction.

The first direction movement D1 is the movement of the vehicle component occurring toward the vehicle body 200 among the movements of the vehicle component occurring in the axial direction of the mount 100 and the inner pipe 110. The vehicle component coupled to the outer pipe 120 may be moved toward the plate 130 or toward the vehicle body 200 by an external force.

The second insulator 150 is vulcanized on one surface of the plate 130 facing the first insulator 140 (see FIG. 6) and is axially spaced apart from the first insulator 140. The second insulator 150 has a shape protruding from the one surface of the plate 130 toward the first insulator 140. By the plate 130, the second insulator 150 is fixed at a position facing the first insulator 140 with a predetermined gap therebetween.

To stop the movement of the vehicle component, the second insulator 150 includes a second axial stopping portion 152 and a radial stopping portion 154.

The second axial stopping portion 152 is provided on the one surface of the plate 130 and is disposed on the same line as the outer pipe 120 in the axial direction. The second axial stopping portion 152 is disposed to have a predetermined gap from the outer pipe 120 in the axial direction. This is to secure a stopping gap between the second axial stopping portion 152 and the outer pipe 120 and to control the movement of the vehicle component using the stopping gap.

The second axial stopping portion 152 is pressed in the axial direction by the outer pipe 120, which moves toward the plate 130 when the vehicle component moves. The second axial stopping portion 152 stops the axial movement of the outer pipe 120. The second axial stopping portion 152 is supported by the plate 130.

The radial stopping portion 154 extends to protrude toward the bridge portion 142 from the second axial stopping portion 152. The radial stopping portion 154 extends in the circumferential direction and is provided in a circular ring structure at the end portion of the second axial stopping portion 152.

Moreover, the radial stopping portion 154 is inserted to be positioned within the first groove 142a in the first insulator 140. To secure the stopping gap, the radial stopping portion 154 has a volume smaller than a volume of the first groove 142a and is disposed within the first groove 142a in a state separated and spaced apart from the bridge portion 142 of the first insulator 140. When the vehicle component neither vibrates nor moves, the radial stopping portion 154 maintains a non-contact state with the bridge portion 142.

The second insulator 150 having said structure may stop the movement of the vehicle component occurred in the axial direction by an external force using the second axial stopping portion 152. Moreover, the second insulator 150 may stop the movement of the vehicle component occurred in the radial direction by an external force using the radial stopping portion 154. The second axial stopping portion 152 may stop a second direction movement (see D2 in FIG. 4) of the vehicle component, and the radial stopping portion 154 may stop all movements of the vehicle component that occur in the radial direction.

The second direction movement D2 is the movement of the vehicle component occurring toward the plate 130 among the movements of the vehicle component occurring in the axial direction of the mount 100 and the inner pipe 110. Furthermore, the second direction movement D2 is a movement in the opposite direction to the previously described first direction movement (see D1 in FIG. 4).

The outer pipe 120 includes a support portion 122 configured to support the first axial stopping portion 144 at the first end portion thereof in the axial direction. The support portion 122 is a portion where the first end portion of the outer pipe 120 is bent outward in the radial direction. The support portion 122 is configured to support the first axial stopping portion 144 that is pressed in the axial direction by the vehicle body 200 when the vehicle component moves toward the vehicle body 200. The support portion 122 extends almost horizontally with the surface of the vehicle body 200.

When the first insulator 140 is vulcanized, the first axial stopping portion 144 is formed on the surface of the support portion 122. When the first direction movement D1 of the vehicle component occurs, the first axial stopping portion 144 is moved toward the vehicle body 200 and is pressed against the vehicle body 200.

Moreover, with respect to the axial direction, the second end portion of the outer pipe 120 is curved inward in the radial direction to surround the first end portion of the bridge portion 142.

The mount 100 having said structure is assembled to the bracket 300 by being press-fitted into the bracket 300 of the vehicle component. Referring to FIG. 5, the outer pipe 120 is assembled to the bracket 300 by being press-fitted into one side (i.e., a pipe coupling portion) of the bracket 300. Furthermore, the stopping gap in the mount 100 may be adjusted by adjusting the size of the insulators 140, 150.

Moreover, the plate 130 serves as a support on which the second insulator 150 is vulcanized, and in addition thereto, the plate 130 also serves to increase the stability of the axial force on the fastening structure including the bolt member 210 and the nut member when assembling the inner pipe 110 to the vehicle body 200.

The vibration insulation mount 100 having said structure operates as follows.

First, when the vehicle component vibrates by an external force, the bridge portion 142 of the first insulator 140 expands and contracts by the vibration of the vehicle component to absorb and insulate the vibration of the vehicle component.

When an external force causes an axial movement of the vehicle component (i.e., the first direction movement), the first axial stopping portion 144 of the first insulator 140 moved together with the vehicle component toward the vehicle body 200 is pressed by the vehicle body 200 to stop the first direction movement D1 of the vehicle component.

When an external force causes an axial movement of the vehicle component (i.e., the second direction movement), the outer pipe 120, moved together with the vehicle component toward the plate 130, presses the second axial stopping portion 152 of the second insulator 150. The second axial stopping portion 152 fixed to the plate 130 is pressed by the outer pipe 120 to stop the second direction movement D2 of the vehicle component.

When an external force causes a radial movement of the vehicle component (see D3 in FIG. 4), the radial stopping portion 154 of the second insulator 150 is pressed toward the inner pipe 110 by the outer pipe 120 being moved together with the vehicle component toward the inner pipe 110. The radial movement D3 of the vehicle component is thereby stopped while being closely adhered to and supported on the outer circumferential surface of the inner pipe 110.

The vibration insulation mount 100 according to an embodiment of the present disclosure having said structure is a bush-type mount and may be effectively used when the vehicle component mounted to the vehicle body is a component that only vibrates and moves by an external force and does not vibrate or move by itself. For example, the mount 100 may be used as a stack mount configured to mount a fuel cell stack on a hydrogen-fueled vehicle.

By using the first insulator 140 and the second insulator 150, the mount 100 may insulate the vibration in all directions (i.e., up-down, left-right, and front-rear directions) of the vehicle component and stop the movement in all directions of the vehicle component.

Moreover, the mount 100 may adjust the stopping gap using the stopping portions 144, 152, 154 and control travel vibration (i.e., driving vibration) caused by an external force. The travel vibration is a vibration component caused by the vibration of the vehicle component by the ground and caused by the movement of the vehicle component by an external force. The vibration component is divided into a primary vibration component, which is an initial shock vibration, and a secondary vibration component, which is the aftershock. In response to the initial shock vibration, the mount 100 may control the amount of large displacement movement of the vehicle component. In response to the aftershock, the mount 100 may control the amount of movement of the vehicle component and reduce the aftershock convergence section.

Furthermore, the mount 100 may improve shake vibration performance against the travel vibration. By changing the shape of the insulators 140, 150 and the hardness of the rubber used when molding the insulators 140, 150, the mount 100 may adjust the degree to which the characteristics of the insulators 140, 150 are improved after stopping the movement of the vehicle component to suit the type of the vehicle. The shake vibration is the secondary component vibration caused when an external force causes movement of a heavy object, such as a powertrain of an internal combustion engine vehicle or power electrics of an electric vehicle.

As should be apparent from the above description, embodiments of the present disclosure provide the following effects.

According to an embodiment of the present disclosure, the first insulator and the second insulator may insulate and stop the vibration and movement of the vehicle component, preventing a shock from the outside from being transmitted to the vehicle component and improving travelling performance of the vehicle.

Effects of the present disclosure are not limited to what has been described above. Other effects not mentioned herein should be more clearly recognized by those having ordinary skill in the art based on the above description.

Terms or words used in this specification and claims described below should not be construed as being limited to conventional or dictionary meanings. In addition, the scope of the present disclosure is not limited to the above-described embodiments. Various modifications and improvements by those having ordinary skill in the art using the basic concept of the present disclosure as defined in the claims below should also be included in the scope of the present disclosure.

What is claimed is:

1. Amount for vibration insulation, the mount comprising:
an inner pipe coupled to a vehicle body;
an outer pipe disposed on an external side of the inner pipe and coupled to a vehicle component mounted to the vehicle body;
a first insulator disposed between the inner pipe and the outer pipe, the first insulator configured to insulate vibration of the vehicle component and to stop a first direction movement of the vehicle component occurring in an axial direction of the inner pipe; and
a second insulator disposed to be axially spaced apart from the first insulator, the second insulator configured to stop a second direction movement of the vehicle component occurring in the axial direction of the inner pipe and a movement of the vehicle component occurring in a radial direction of the inner pipe.

2. The mount of claim 1, wherein the second insulator is disposed on a plate coupled to an end portion of the inner pipe, and the second insulator is fixed by the plate at a position facing the first insulator with a predetermined gap therebetween.

3. The mount of claim 2, wherein the first insulator comprises:
a bridge portion disposed between the inner pipe and the outer pipe, wherein the bridge portion is glued to an outer circumferential surface of the inner pipe and to an inner circumferential surface of the outer pipe; and
a first axial stopping portion extending from a first end portion of the bridge portion and facing the vehicle body with a predetermined gap therebetween.

4. The mount of claim 3, wherein the bridge portion has a second end portion having a recessed groove.

5. The mount of claim 4, wherein the second insulator comprises:
a second axial stopping portion disposed on the plate and being axially spaced apart from the outer pipe; and
a radial stopping portion extending toward the bridge portion from the second axial stopping portion and being disposed within the groove.

6. The mount of claim 5, wherein the radial stopping portion has a volume smaller than a volume of the groove and is separated from the bridge portion.

7. The mount of claim 3, wherein the outer pipe has an end portion with a support portion configured to support the first axial stopping portion selectively pressed by the vehicle body.
